(19) United States
(12) Patent Application Publication
(10) Pub. No.: US 2003/0051596 A1
(43) Pub. Date: Mar. 20, 2003

(54) Electromagnetic microphone for string instruments

(76) Inventor: Peter Gustafsson, Stockholm (SE)

Correspondence Address: Nixon & Vanderhye, 8th Floor, 1100 North Glebe Road, Arlington, VA, 22201-4714, US

(21) Appl. No.: 10/149,594

(22) PCT Filed: Dec. 11, 2000
(86) PCT No.: PCT/SE00/02475

(30) Foreign Application Priority Data
Dec. 14, 1999 (SE) 9904568-4

(51) Int. Cl. G10H 3/00

(52) U.S. Cl. 84/723

(57) ABSTRACT

An electromagnetic microphone for string instruments provided to register vibrations in a magnetised string/strings (1), in which at least one coil (2) is provided to register the sideway oscillation of the strings (1).

The present invention relates to an electromagnetic microphone for string instruments.

Conventional electromagnetic microphones for, for example, electrical guitars register the oscillation of the strings vertically, i.e. to and from the microphone. One or more permanent magnets is used to magnetise the steel strings and a coil is wound around a core. When the strings move towards and away from the coil, current is induced in the coil, which then is amplified.

One problem with the conventional electromagnetic microphones is the fact that they register the oscillation of the strings vertically and not their oscillation sideways, whereby they cannot register the impact of the tone and not represent a realistic acoustic timbre. The expression impact is meant to be the beginning of the tone when the strings of the string instrument is affected sideways to produce a tone. The brain experience that a tone without impact is made artificially, for example by a synthesiser. An electric guitar, for example, has a sound that radically differs from an acoustic guitar.

A conventional electromagnetic microphone does not function together with string instruments using a bow since these are sensitive to the direction. The bow thus forces the string to vibrate in the direction of the bow movement and when the bow leaves a string it begins to vibrate freely. With a conventional microphone the freely oscillating string will drown the string that currently is played by the bow.

Previously known are piezoelectric microphones, which can register the sideway oscillation of the strings. These microphones are generally designed for positioning at the bridge or at the resonance board. Such a position makes them sensitive to acoustic feedback. Piezoelectric microphones without these characteristics are very expensive to manufacture.

The object of the present invention is to provide a way to represent the tones from a string instrument having as realistic acoustic timbre as possible in an inexpensive way.

According to the invention this object is met by a microphone according to the preamble, which is characterised in that the microphone comprises at least one coil so provided to register a sideway oscillation of a magnetised string.

The advantage of this arrangement is that it is possible to provide a microphone that can register the impact of the tone and its acoustic timbre and the fact that it is possible to use a bow to produce the tone. Further, such a microphone strongly suppress tendencies to acoustic feedback.

Preferably the coils are air-cored, i.e. they do not have any core within the windings.

According to a first embodiment of the invention, the coils are provided so that the central axes of the coils lie in a plane, which is parallel to the plane of the strings and are orthoganally directed to the extension of the strings.

According to a first variant of the first embodiment, one coil per string is provided substantially straight underneath the string and a permanent magnet per pair of strings is provided between the two strings, substantially in the same plane as the coils.

According to a second variant of the first embodiment one coil is provided substantially straight underneath each string and permanent magnets are provided, one at each side of each string, substantially in the same plane as the coils. This variant has the advantage compared to the first variant that it provides a more even magnetic field.

According to a third variant of the first embodiment, one coil per pair of strings is provided substantially between and underneath the strings of the pair and permanent magnets are provided between the coils and at their outer sides, substantially in the same plane as the coils, so that the coils have a permanent magnet at each of its sides.

According to a fourth variant of the first embodiment one coil per pair of strings is provided substantially between and underneath the strings of the pair and a permanent magnet is positioned under each coil.

According to a first variant of a second embodiment of the present invention the coils are provided so that the centre axes of the coils are orthogonally arranged to a plane, which is parallel to the plan of the strings.

According to a second variant of the second embodiment each coil, which are provided between the strings and at their outer edges in a plane substantially parallel to the plane of the strings, is provided with a magnetic core inside, which is oriented in a direction orthogonally to the plane of the strings. This variant has the advantage of providing a stronger output signal from the first variant.

According to a third variant of the second embodiment two coils are displaced relative each other and each coil comprises one core per string which are provided, in the first coil, at one side of the strings and, in the second coil, on the other side of the strings, respectively.

The coils may be either connected in series or in parallel to an amplifier or in parallel to an amplifier each. The amplifier may be an OP-amplifier or a balanced transformer. Connection in series provides a higher level of efficiency, since coils connected in parallel are a load to each other, but may possibly give unwanted colourings of the tones. If the coils are connected in parallel to an amplifier each the advantages of both of the types of connections are achieved and additionally it is simple to fine-tune the mutual balance of the strings.

The present invention will now be described in detail by non-limiting examples of embodiments and referrals to the appended drawings, in which:

FIG. 1 schematically illustrates a first variant of a first embodiment of the present invention,

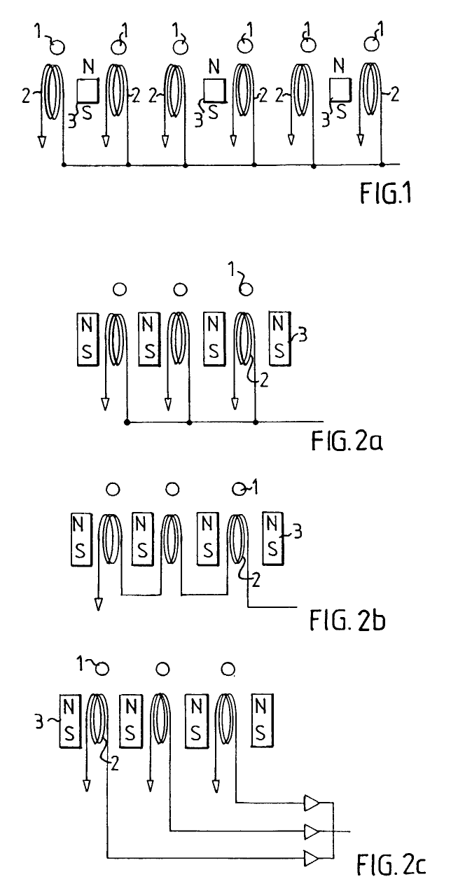

FIG. 2a schematically illustrates coils connected in parallel,

FIG. 2b schematically illustrates coils connected in series,

FIG. 2c schematically illustrates coils, which are connected in parallel to an amplifier each,

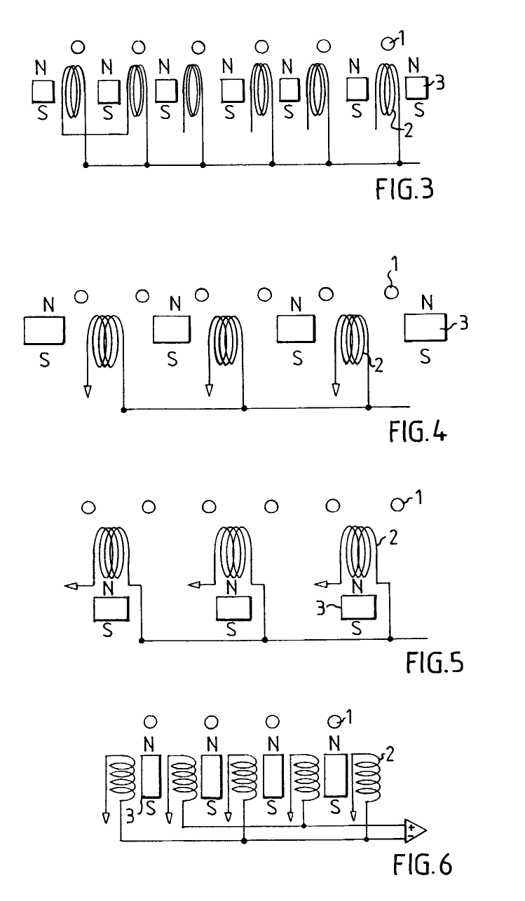

FIG. 3 schematically illustrates a second variant of the first embodiment of the present invention,

FIG. 4 schematically illustrates a third variant of the first embodiment of the present invention,

FIG. 5 schematically illustrates a fourth variant of the first embodiment of the present invention,

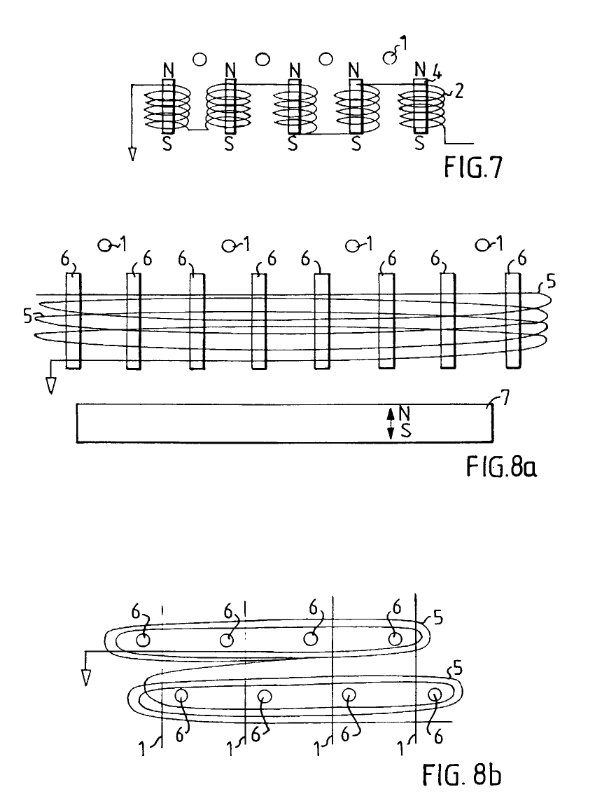

FIG. 6 schematically illustrates a first variant of a second embodiment of the present invention,

FIG. 7 schematically illustrates a second variant of the second embodiment of the present invention,

FIG. 8a schematically illustrates a third variant of the second embodiment from the side,

FIG. 8b schematically illustrates the third variant of the second embodiment from above.

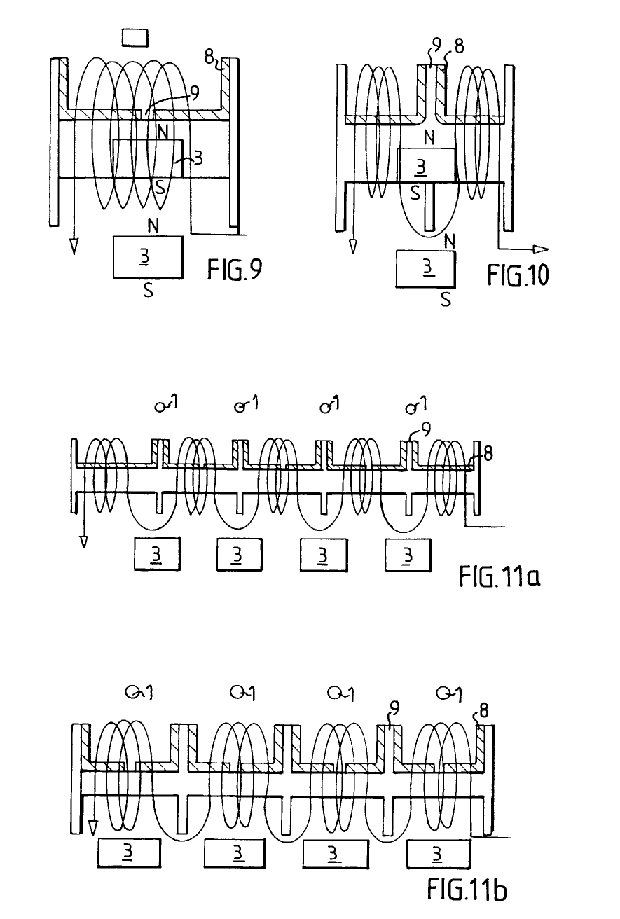

FIG. 9 illustrates a microphone comprising a metal screen,

FIG. 10 illustrates a microphone comprising a metal screen according to a further embodiment,

FIG. 11a illustrates a microphone with a metal screen for a plurality of strings, and

FIG. 11b illustrates a microphone with a metal screen for a plurality of strings according to a further embodiment.

In FIG. 1 a six string instrument is shown but the invention may of course be designed to suit a chosen number of strings 1. The strings 1 in FIG. 1 forms a plane, as well as the body of the instrument (not shown) forms a plane underneath the plane of the strings 1. In between an electromagnetic microphone is provided, which comprises air-cored coils 2, i.e. without cores, arranged so that the centre axes of the coils 2 substantially lies in a plane parallel to the plane of the strings 1, in this case underneath the plane of the strings 1 and above the plane of the body of the instrument. The coils 2 are oriented, i.e. their centre axes are oriented, in a direction substantially orthogonally to the extension of the strings 1.

In a first variant of the first embodiment a coil 2 is arranged substantially straight underneath each string 1. A permanent magnet 3 is provided between each pair of strings 1, preferably in substantially the same plane as the coils 2, to magnetise the strings 1, which of course must be made of a magnetisable material, for example steel. For a six string instrument it is thus needed six coils 2 and three permanent magnets 3. The permanent magnets 3 are oriented with its north-south direction orthogonally to the plane of the strings 1. All of the permanent magnets must be directed in the same direction, for example having the north end directing upwards.

In FIG. 1 the coils 2 are connected in parallel to an amplifier (not shown) but they may also be connected in series to an amplifier or the coils 2 may be connected in parallel to an amplifier each, see FIGS. 2a, 2b and 2c. The amplifier may for example be an OP-amplifier or a balanced transformer.

When the strings 1 move sideways current will be induced in the coils 2 which is amplified and transformed into audible sound by amplifiers and loudspeakers. The movement upwards and downwards of the strings 1 is not registered by the coils 2.

In FIG. 3 a second variant of the first embodiment is illustrated where a coil 2 is arranged substantially straight underneath each string 1, exactly as in the first variant. In this variant permanent magnets 3 are arranged between each coil 2 and additionally at its outer sides so that each coil 2 has a permanent magnet 3 at both sides thereof, substantially in the same plane as the coils. Thus in the shown case with six strings and seven magnets 3 are needed. Also in the second variant the coils 2 may be connected in parallel or in series to an amplifier or in parallel to an amplifier each.

In FIG. 4 a third variant of the first embodiment is shown where a coil 2 is arranged substantially between each pair of strings and in a plane under the strings 1. Between the coils 2 permanent magnets 3 are arranged, and at the outer sides of the coils 2, substantially in the same plane as the coils 2, so that the coils 2 have a permanent magnet 3 at each side. For a six string instrument three coils 2 and four permanent magnets 3 thus are needed. Also in this variant the coils 2 may be connected in parallel or in series to an amplifier or in parallel to an amplifier each.

In FIG. 5 a fourth variant of the first embodiment is shown where a coil 2 is arranged substantially between each pair of strings and in a plane underneath the string 1. A permanent magnet 3 is positioned under each coil 2. As well as in previously described variants the coils 2 may be connected in parallel or in series to an amplifier or in parallel to an amplifier each.

Referring to FIG. 6 a second embodiment of the present invention will be described. An electromagnetic microphone is schematically illustrated, the microphone comprises air-cored coils 2, i.e. without cores, arranged so that the centre axes of the coils 2 are substantially orthogonal to the plane of the strings 1, and permanent magnets 3 and, also in this case, underneath the plane of the strings 7 and above the plane of the instrument body. These coils 2 are connected in reverse phase to each other. Then they counteract each other so that a movement of the strings 1 towards and away from the coils, i.e. upwards and downwards, induces current in the coils 2 that neutralise each other, whereby no resulting registration of the upwards and downwards movement of the strings 1 occur. However, the movement of the strings 1 sideways induces currents in the coils 2 that are not neutralised by each other, whereby these currents are amplified and led to, for example, a loudspeaker.

As may be seen in FIG. 6, in a first variant of the second embodiment, a permanent magnet 3 is provided underneath each string 1 substantially in a plane underneath the plane of the strings 1. Between the permanent magnets 3 and at the outer sides of the permanent magnets 3 coils 2 are arranged so that the permanent magnets 3 has a coil 2 at both sides thereof. Preferably the coils 2 are arranged substantially in the same plane as the permanent magnets 3. Also in this embodiment the coils 2 may be connected in parallel or in series to a balanced amplifier or ditto transformer.

In FIG. 7 a second variant of the second embodiment is shown. Each coil 2, which are provided between the strings 1 and at their outer sides in a plane substantially parallel to the plane 1 of the strings, is provided with a magnetic core 4 inside, which is oriented in a direction orthogonally to the plane of the strings 1. In this figure it is illustrated that the coils 2 are connected in series alternating in phase and, reverse phase, respectively, but may of course be connected in parallel, as shown in FIG. 6.

In FIG. 8a and 8b a third variant of the second embodiment. Two coils 5 are connected in phase and in reverse phase, respectively. Underneath the coils 5 an elongated permanent magnet 7 is arranged with its north-south direction orthogonally to the plane of the strings 1. Inside each coil 5 a number of cores 6, corresponding to the number of strings 1, are provided in one of the coils 5 at one side of the strings 1 and in the other coil 5 on the other side of the strings 1, i.e. the coils are displaced in relation to each other. Due to the displacement the induced currents occuring due to the movements of the strings 1 upwards and downwards are neutralised. Therefore, only the movements of the strings 1 sideways are registered. The cores 6 may be magnetic cores (whereby the bottom magnet is not needed) or iron cores and ought to protrude above the edge of the coil. It is also possible to place permanent magnets 3 between the cores 6 instead of underneath. Both of the coils 5 with their cores 6 may be inclined towards each other so that the tops of the cores 6 will be in the same line.

The different variants of the second embodiment may be reconnected to a conventional microphone that register the movements of the strings upwards and downwards.

Further it is illustrated in FIG. 9 another embodiment. In the embodiment shown in FIG. 9 a piece of metal 8 is arranged between the coil 8 and the magnetised string. The piece of metal, which preferably is made of a magnetisable material, is further provided with an air gap 9. The object of the metal screen with the air gap is to screen the underside of the winding from the magnetised string. According to another preferred embodiment (not shown) the piece of metal may be provided without any air gap. This also applies to the embodiments of FIGS. 10 and 11. Further the frame of the coil may be formed with a rectangular cross section.

In FIG. 10 a variant of the embodiment of FIG. 9 is shown. In the embodiment in FIG. 10 the frame around which the winding are wound is divided into two sections. The winding in each section is wound in opposite direction to the adjacent section.

In FIGS. 11a and 11b the microphone described referring to FIGS. 9 and 10 is shown in the case where more strings are provided. The frame of the coil is then preferably designed with a plurality of sections where the winding in each section goes in the opposite direction to the winding in the adjacent section. Two embodiments are possible. In a first embodiment the microphone is so positioned that the strings are present at the border between two windings, FIG. 11a. In this case an extra section compared to the case where the strings are positioned above the middle of each winding, FIG. 11b, is needed.

Finally measurements has shown that by placing the string precisely above the border between two coils the horizontal oscillation of the string is registered in a larger extent. On the other hand, if the string is displaced sideways the microphone will be more sensitive to sideway oscillations. Thus, the microphone may be set to register a wanted relation between sideway and horizontal oscillations.

1. An electromagnetic microphone for registering vibrations in strings provided on a string instrument mainly in one plane, comprising at least one permanent magnet (3) for magnetising the strings (1), and at least one coil (2) in which a current is induced by movements of the strings (1), characterised in that the coil or coils (2) are arranged having their centre axes oriented parallel to the string plane and orthogonal to the extension of the strings (1), such that sideway oscillations of the strings (1) are registered by current induction in the coil or coils (2).

2. A microphone according to claim 1, characterised in that the coil or coils (2) are air-cored, i.e. without a core.

3. A microphone according to claim 1 or 2, characterised in that one coil (2) is arranged for each string substantially straight underneath the string (1), and that one permanent magnet (3) is arranged for each pair of strings between the two strings (1) in substantially the same plane as the coils (2).

4. A microphone according to claim 1 or 2, characterised in that one coil (2) is arranged substantially straight underneath each string (1), and that permanent magnets (3) are arranged, one at each side of each string (1), in substantially the same plane as the coils (2).

5. A microphone according to claim 1 or 2, characterised in that one coil (2) is arranged for each pair of strings substantially between and underneath the strings (1) of the pair, and that permanent magnets (3) are arranged between the coils (2), and at the outer sides thereof, in substantially the same plane as the coils (2), such that the coils (2) have a permanent magnet (3) at each side thereof.

6. A microphone according to claim 1 or 2, characterized in that one coil (2) is arranged for each pair of strings substantially between and underneath the strings (1) of the pair, and that one permanent magnet (3) is positioned underneath each coil (2).
